(19) United States
(12) Patent Application Publication
(10) Pub. No.: US 2017/0095738 A1
(43) Pub. Date: Apr. 6, 2017

(54) USER MOVEMENT FEEDBACK VIA ON-SCREEN AVATARS

(71) Applicant: MICROSOFT TECHNOLOGY LICENSING, LLC, REDMOND, WA (US)

(72) Inventors: EDWARD C. GIAIMO, REDMOND, WA (US); TIMOTHY J. PARSEY, REDMOND, WA (US)

(21) Appl. No.: 15/382,052

(22) Filed: Dec. 16, 2016

Related U.S. Application Data
(63) Continuation of application No. 12/475,304, filed on May 29, 2009.

(51) Int. Cl. A63F 13/537; A63F 13/67

(52) U.S. Cl. CPC A63F 13/537; A63F 13/67

(57) ABSTRACT

The following discloses using avatars to provide feedback to users of a gesture-based computing environment about one or more features of the gesture-based computing environment. Gesture-based computing environments may not, in some circumstances, use a physical controller that associates a player with the computing environment. Accordingly, a player may not be provided with a player number. Thus rights and features typically associated with a particular controller may not be available to a user of a gesture-based system.

### CROSS-REFERENCE TO RELATED APPLICATIONS

This application is a continuation of U.S. patent application Ser. No. 12/475,304, filed on May 29, 2009, and titled “User Movement Feedback via On-Screen Avatars,” the content of which is incorporated by reference herein in its entirety.

### BACKGROUND

Many computing applications such as computer games, multimedia applications, office applications or the like use controls to allow users to manipulate game characters or other aspects of an application. Typically such controls are input using, for example, controllers, remotes, keyboards, mice, or the like. Unfortunately, such controls can be difficult to learn, thus creating a barrier between a user and such games and applications. Furthermore, such controls may be different than actual game actions or other application actions for which the controls are used.

### SUMMARY

The following discloses using avatars to provide feedback to users of a gesture-based computing environment in which user input is determined by recognizing gestures, movement or poses of a user. Such a gesture-based computing environment may not use a physical controller that associates a player with the computing environment. Accordingly, a player may not be provided with a player number or identifier based on a physical controller. Thus, capabilities, privileges, rights and features typically associated with a particular controller may instead be associated with a recognized user and feedback to the user about his or her rights, capabilities, features, permissions etc., may be provided via a user avatar. For example, the feedback may inform the user that the user is being “recognized” by the system or that he or she is bound as a controller to the system, or the feedback may indicate the responsiveness of the system to the user's recognized gestures, a particular player number that may be assigned to the user, whether the user is within the capture area of the system, or when the user may input gestures and the like.

Aspects of an avatar associated with a user may change when the user has certain rights, features or permissions associated with them. For example, if a user has the right to select a level or track in a gaming environment, their avatar may change size, brightness, color, position on the screen, position in a depicted arrangement of avatars, gain one or more objects or the like, or even appear on the screen. This may be particularly important in circumstances where two or more users may simultaneously be in a capture area of a gesture-based computing environment.

Aspects of a gesture-based computing environment may introduce situations where user feedback is required in order for the system to properly receive gesture-based commands from a user. For example, a user may step partially out of a capture area. In order to return to the capture area, a user may need feedback from the system informing them that they are either partially or fully out of a capture area. Further, this feedback may be provided in the form of visual feedback based on a change to one or more aspects of the avatar.

The avatar may provide feedback to the user about the responsiveness of a gesture-based computing environment to a gesture made by the user. For example, if a user raises their arm to a certain height, the avatar associated with the user may also raise their arm and the user can see how high they must raise their arm in order to make the avatar fully extend its arm. Accordingly, the user may be provided feedback about the extent to which they must gesture in order to receive a desired response from the system.

In addition, the avatar may be used to inform a user when they have the right to enter gesture-based commands in the gesture-based computing environment as well as what type of commands they may enter. For example, in a racing game, when the avatar is situated in a vehicle, the user may learn from that placement that they have control over a particular vehicle and that they may enter certain gestures specific to controlling the vehicle as commands to the computing environment.

A user may hold an object to control one or more aspects of a gesture-based computing environment. The gesture-based system may detect, track and model the object and place a virtual object in the hands of the avatar. One or more aspects of the object may change to inform the user of features of the object. For example, if the object is not in the capture area, aspects of the object may change. As another example, a user may hold a short handle that represents, for example, a light saber. The virtual object held by the avatar may include the extent of the short handle along with the virtual ‘blade’ of the light saber.

### BRIEF DESCRIPTION OF THE DRAWINGS

FIGS. 1A, 1B through 1C illustrate an example embodiment of a gesture-based control system with a user playing a game.

FIG. 2 illustrates an example embodiment of a capture device that may be used in a gesture-based system.

FIG. 3 illustrates an example embodiment of a computing environment that may be used to interpret one or more gestures of a user bound to the gesture-based system and associated with the virtual port.

FIG. 4 illustrates another example embodiment of a computing environment that may be used to interpret one or more gestures of a user bound to the gesture-based system and associated with the virtual port.

FIG. 5 illustrates an example of a previous control environment for a gaming system where controllers, connected with a cable or wirelessly may be used to control a computing environment.

FIG. 6 illustrates multiple users in a capture area of a gesture-based system that may be bound the users, provide feedback to them and associate them with a virtual port.

FIG. 7 illustrates one example of a user as he may be modeled by a gesture-based system, where the user is modeled as joints and limbs, and the motion of these joints and limbs may be used to interpret gestures for a gesture-based computing environment.

FIG. 8 depicts a series of sample avatars that may be provided on a display screen.

FIG. 9 depicts a flow chart for associating avatars with users and providing feedback to the user via the avatar.

FIG. 10 depicts a flow chart for providing a user with feedback about their position in a capture area.

FIG. 11 depicts a flow chart for associating multiple users with avatars and providing feedback to those users via the avatars.

FIG. 12 depicts a flow chart for associating an avatar with a user and providing feedback about the users gestures via the avatar.

### DETAILED DESCRIPTION OF ILLUSTRATIVE EMBODIMENTS

As will be described herein, a gesture-based system may detect a user and associate the user with an avatar. The avatar may be used to provide feedback to the user about one or more capabilities, features, rights or privileges associated with the user. The features, rights, and privileges may include, for example, the right to make a menu selection, enter a command, the responsiveness of the system to a gesture, information about the direction a user needs to move in order to center themselves in a capture area, and the like. In a non-gesture based computing environment the features, rights, and privileges may be associated with a physical controller. A gesture-based system, however, may need to provide feedback to a user about these permissions, rights, or privileges because the user no longer has the physical controller.

In one embodiment, the avatar may be situated in a computing environment and displayed on the display screen is such a way as to provide a user with information about the rights a user has. For example, if an avatar is seen with a prop such as a weapon or behind the wheel of an automobile in a virtual world, the user may have gesture-based control over those objects. Thus, providing the user with visual feedback of their current status and privileges in the computing environment provides the user with information necessary to make decisions about the input to provide to the gesture-based system and the actions of the avatar.

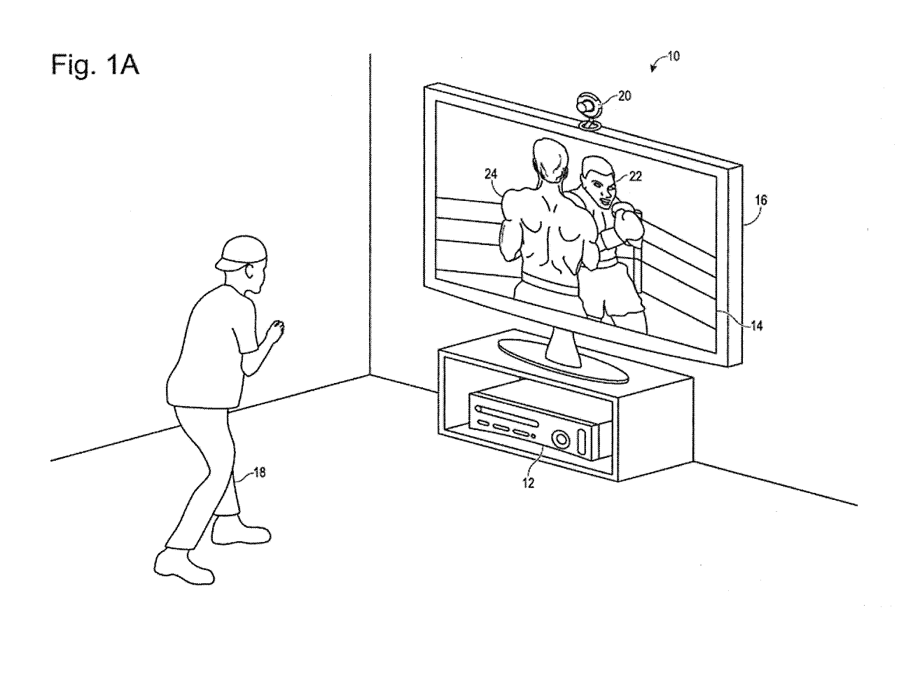

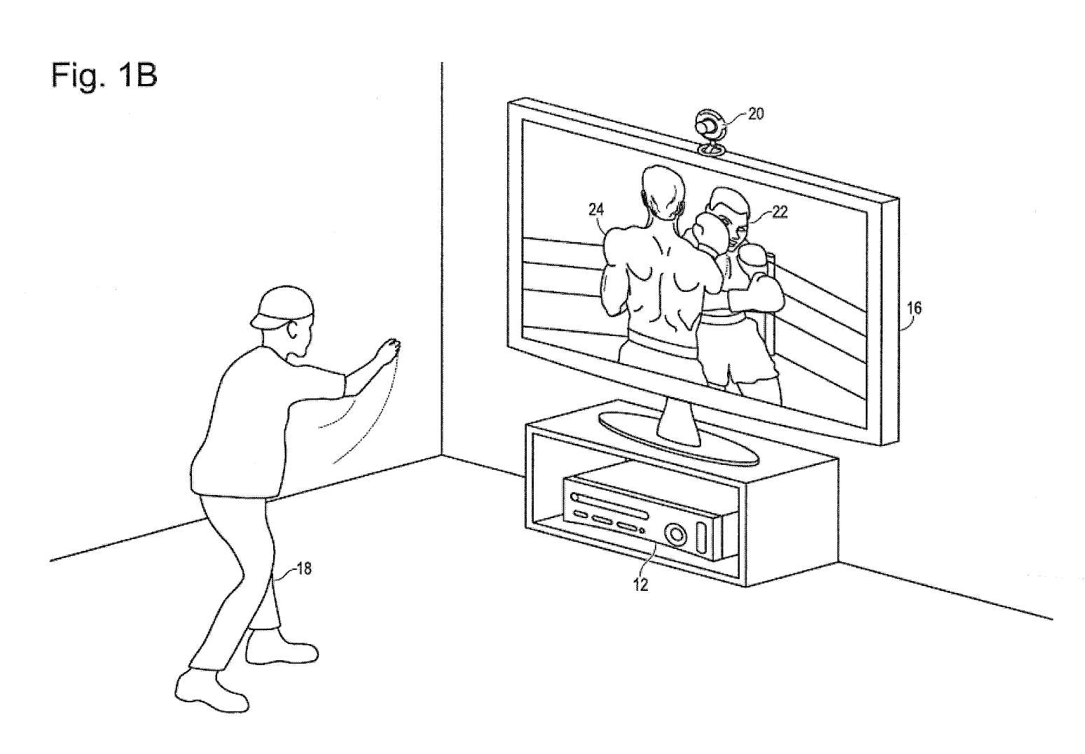

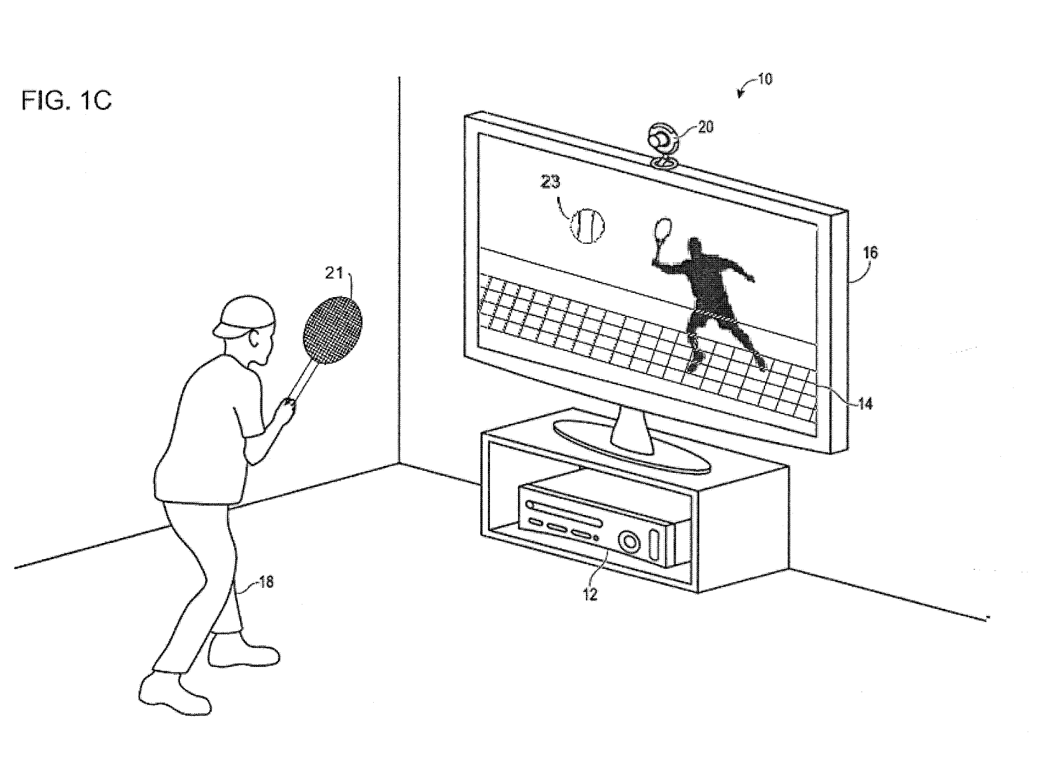

FIGS. 1A and 1B illustrate an example embodiment of a configuration of a gesture-based system 10 with a user 18 playing a boxing game. In an example embodiment, the gesture-based system 10 may be used to bind, recognize, analyze, track, create an avatar, associate features, rights, or privileges, associate to a human target, provide feedback, receive gesture-based input, and/or adapt to aspects of the human target such as the user 18.

As shown in FIG. 1A, the gesture-based system 10 may include a computing environment 12. The computing environment 12 may be a computer, a gaming system, console, or the like. According to an example embodiment, the computing environment 12 may include hardware components and/or software components such that the computing environment 12 may be used to execute applications such as gaming applications, non-gaming applications, or the like.

As shown in FIG. 1A, the gesture-based system 10 may further include a capture device 20. The capture device 20 may be, for example, a detector that may be used to monitor one or more users, such as the user 18, such that gestures performed by the one or more users may be captured, analyzed, and tracked to provide a user feedback and perform one or more controls or actions within an application, as will be described in more detail below.

According to one embodiment, the gesture-based system 10 may be connected to an audiovisual device 16 such as a television, a monitor, a high-definition television (HDTV), or the like that may display an avatar, provide feedback about rights, features and privileges associated with a user, the user's movements, virtual ports, binding, game or application visuals and/or audio to the user 18. For example, the computing environment 12 may include a video adapter such as a graphics card and/or an audio adapter such as a sound card that may provide audiovisual signals associated with the feedback about features, rights and privileges, game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, a wireless connection or the like.

As shown in FIGS. 1A and 1B, the gesture-based system 10 may be used to model, recognize, analyze, and/or track a human target such as the user 18. For example, the user 18 may be tracked using the capture device 20 such that the position, movements and size of user 18 may be interpreted as controls that may be used to affect the application being executed by computer environment 12. Thus, according to one embodiment, the user 18 may move his or her body to control the application.

As shown in FIGS. 1A and 1B, in an example embodiment, the application executing on the computing environment 12 may be a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a user avatar 24 that the user 18 may control with his or her movements on a screen 14. For example, as shown in FIG. 1B, the user 18 may throw a punch in physical space to cause the user avatar 24 to throw a punch in game space. Thus, according to an example embodiment, the computer environment 12 and the capture device 20 of the gesture-based system 10 may be used to recognize and analyze the punch of the user 18 in physical space such that the punch may be interpreted as a game control of the user avatar 24 in game space.

In one embodiment the user avatar 24 may be specific to the user 18. The user 18 may play any number of games, where each game may allow for use of a user avatar 24. In one embodiment, the user may create the avatar 24 from a list of menu options. In another embodiment, the avatar 24 may be created by detecting one or more aspects of a user 18, such as, for example, their hair color, height, size, color of shirt or any other features of a user 18 and then providing an avatar based on the aspects of the user 18. As another example, the avatar 24 may start as a representation of a user captured by the capture device, which a user may then alter in any fashion, by adding or removing any features, adding fanciful elements and the like.

Other movements or poses by the user 18 may also be interpreted as other controls or actions, such as controls to run, walk, accelerate, slow, stop, shift gears or weapons, aim, fire, duck, jump, grab, open, close, strum, play, swing, lean, look, bob, weave, shuffle, block, jab, throw a variety of different power punches or the like. Any other controls or actions that may be required to control an avatar, or otherwise control a computer environment are included. Furthermore, some movements or poses may be interpreted as controls that may correspond to actions other than controlling the user avatar 24. For example, the user may use movements or poses to enter, exit, turn system on or off, pause, volunteer, switch virtual ports, save a game, select a level, profile or menu, view high scores, communicate with a friend, etc. Additionally, a full range of motion of the user 18 may be available, used, and analyzed in any suitable manner to interact with an application. These movements and poses may be any movement or pose available to a user, and may include entering and exiting a capture area. For example, in one embodiment, entering a scene may be an entry gesture or command in the gesture-based system.

As depicted in FIG. 1C, the human target, such as the user 18, may have an object. In such embodiments, the user of an electronic game may be holding the object such that the motions of the user and the object may be used to adjust and/or control parameters of the game. For example, the motion of a user holding a racket 21 may be tracked and utilized for controlling an on-screen racket to hit a ball 23 in an electronic sports game. In another example embodiment, the motion of a user holding an object may be tracked and utilized for controlling an on-screen weapon in an electronic combat game. Any other object may also be included, such as one or more gloves, balls, bats, clubs, guitars, microphones, sticks, pets, animals, drums and the like.

In another embodiment, a user avatar 24 may be depicted on an audiovisual display with one or more objects. As a first example, the gesture-based system may detect an object such as racket 21, which the system may model, track or the like. The avatar may be depicted with the object that the user is holding, and the virtual object may track the motions of the physical object in the capture area. In such an example, if the object moves out of the capture area, one or more aspects of the virtual object held by the avatar may change. For example, if the racket is moved partially or fully out of the capture area, the virtual object held by the avatar may brighten, dim, increase or decrease in size, change color, disappear or change in any other way to provide feedback to the user about the state of the object in the capture area.

In another embodiment, the avatar 24 may be depicted with an object in order to provide the user feedback about a right, privilege or feature associated with the user. For example, if the user is playing a track and field game, and the avatar is depicted first without; and then with, a relay race baton, the user may know when they may need to perform one or more tasks. As another example, if there is a quiz show type game, the avatar may be provided with a buzzer onscreen, which will inform the user that he or she has the right to buzz in. As a further example, if there are multiple users and there is a menu selection option, the user that has the right to make a selection on the menu screen may be provided with an object to indicate to the user that the user has a right to make the menu selection.

According to other example embodiments, the gesture-based system 10 may be used to interpret target movements and poses as operating system and/or application controls that are outside the realm of games. For example, virtually any controllable aspect of an operating system and/or application may be controlled by movements or poses of the target such as the user 18.

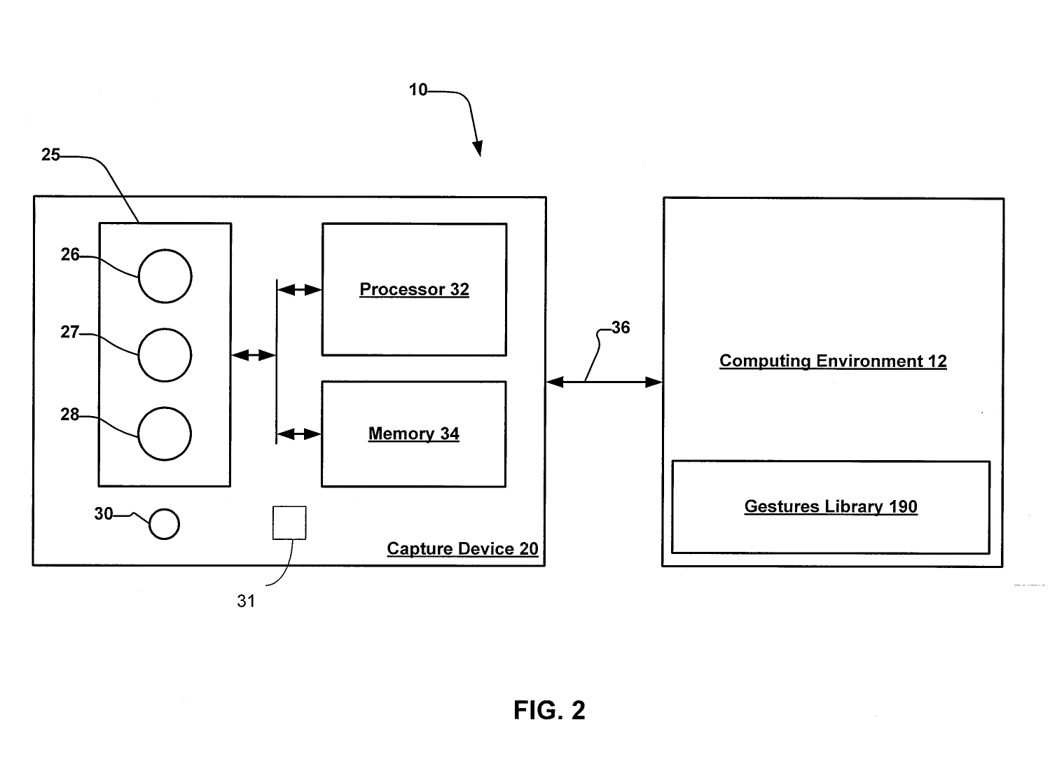

FIG. 2 illustrates an example embodiment of the capture device 20 that may be used in the gesture-based system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, according to an example embodiment, the image camera component 25 may include an IR light component 26, a three-dimensional (3-D) camera 27, and an RGB camera 28 that may be used to capture the depth image of a scene. For example, in time-of-flight analysis, the IR light component 26 of the capture device 20 may emit an infrared light onto the scene and may then use sensors (not shown) to detect the backscattered light from the surface of one or more targets and objects in the scene using, for example, the 3-D camera 27 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern or a stripe pattern) may be projected onto the scene via, for example, the IR light component 26. Upon striking the surface of one or more targets or objects in the scene, the pattern may become deformed in response. Such a deformation of the pattern may be captured by, for example, the 3-D camera 27 and/or the RGB camera 28 and may then be analyzed to determine a physical distance from the capture device to a particular location on the targets or objects.

According to another embodiment, the capture device 20 may include two or more physically separated cameras that may view a scene from different angles, to obtain visual stereo data that may be resolved to generate depth information

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the gesture-based system 10. Additionally, the microphone 30 may be used to receive audio signals that may also be provided by the user to control applications such as game applications, non-game applications, or the like that may be executed by the computing environment 12.

The capture device 20 may further include a feedback component 31. The feedback component 31 may comprise a light such as an LED or a light bulb, a speaker or the like. The feedback device may perform at least one of changing colors, turning on or off, increasing or decreasing in brightness, and flashing at varying speeds. The feedback component 31 may also comprise a speaker which may provide one or more sounds or noises as a feedback of one or more states. The feedback component may also work in combination with computing environment 12 or processor 32 to provide one or more forms of feedback to a user by means of any other element of the capture device, the gesture-based system or the like.

In an example embodiment, the capture device 20 may further include a processor 32 that may be in operative communication with the image camera component 25. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, user profiles or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 25 and the processor 32. According to another embodiment, the memory component 34 may be integrated into the processor 32 and/or the image capture component 25.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 27 and/or the RGB camera 28, and a skeletal model that may be generated by the capture device 20 to the computing environment 12 via the communication link 36. The computing environment 12 may then use the skeletal model, depth information, and captured images to, for example, create a virtual screen, adapt the user interface and control an application such as a game or word processor. For example, as shown, in FIG. 2, the computing environment 12 may include a gestures library 190. The gestures library 190 may include a collection of gesture filters, each comprising information concerning a gesture that may be performed by the skeletal model (as the user moves). The data captured by the cameras 26, 27 and device 20 in the form of the skeletal model and movements associated with it may be compared to the gesture filters in the gesture library 190 to identify when a user (as represented by the skeletal model) has performed one or more gestures. Those gestures may be associated with various controls of an application. Thus, the computing environment 12 may use the gestures library 190 to interpret movements of the skeletal model and to control an application based on the movements.

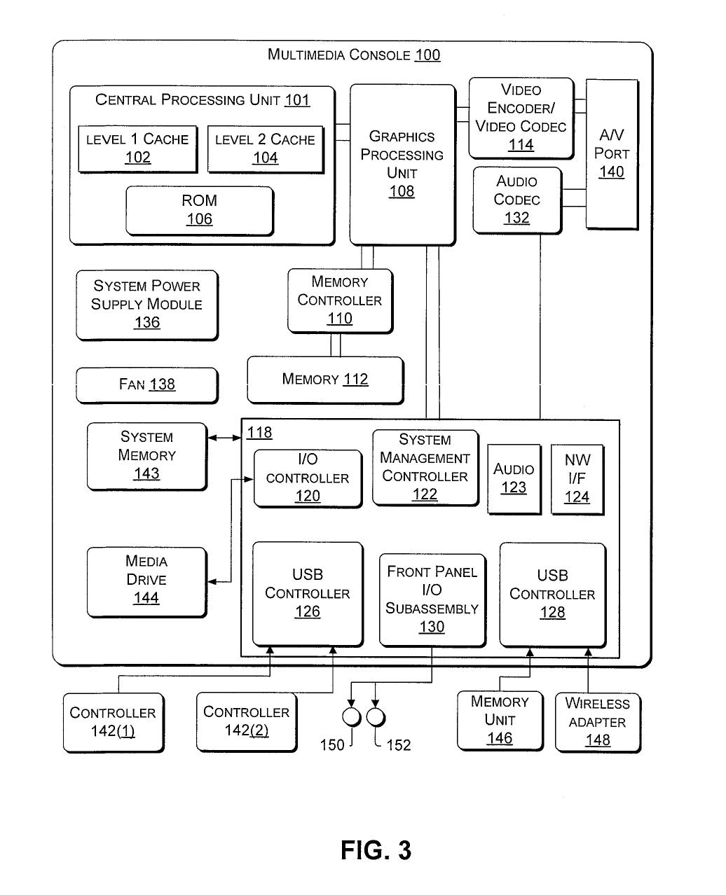

FIG. 3 illustrates an example embodiment of a computing environment that may be used to implement computing environment 12 of FIGS. 1A-2. The computing environment 12 may comprise a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The front panel I/O subassembly 130 may include LEDs, a visual display screen, light bulbs, a speaker or any other means that may provide audio or visual feedback of the state of control of the multimedia control 100 to a user 18. For example, if the system is in a state where no users are detected by capture device 20, such a state may be reflected on front panel I/O subassembly 130. If the state of the system changes, for example, a user becomes bound to the system, the feedback state may be updated on the front panel I/O subassembly to reflect the change in states.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 27, 28 and capture device 20 may define additional input devices for the console 100.

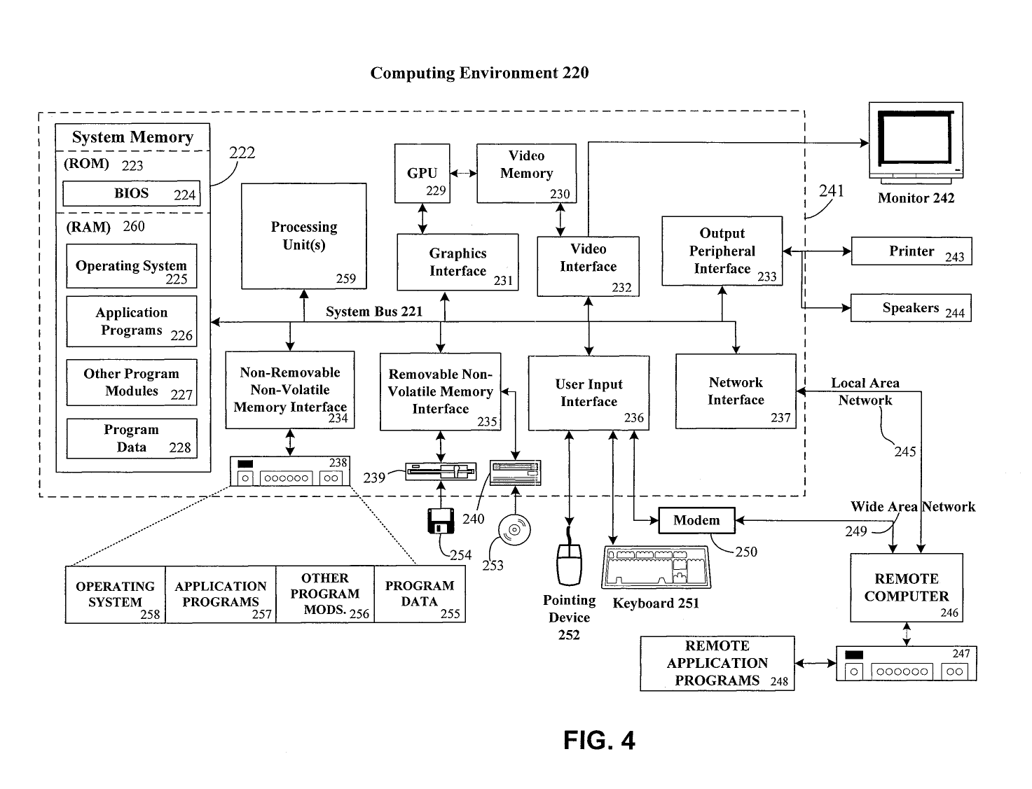

FIG. 4 illustrates another example embodiment of a computing environment 220 that may be used to implement the computing environment 12 shown in FIGS. 1A-2. The computing environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, capture device or the like. These and other input devices are often connected to the processing unit 259 through a user input interface 236 that is coupled to the system bus, but may be connected by other interface and bus structures, such as a parallel port, game port or a universal serial bus (USB). The cameras 27, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

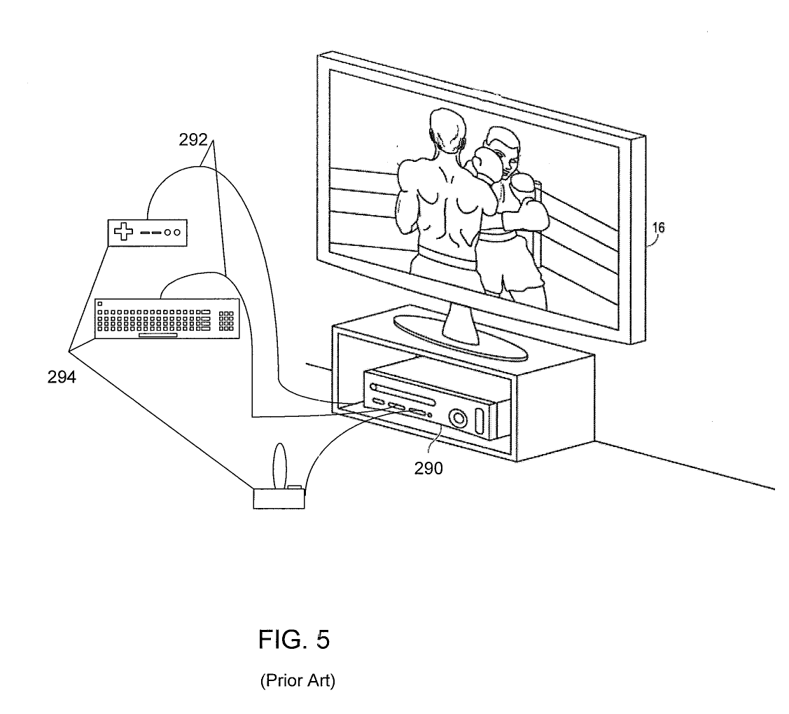

FIG. 5 illustrates an example embodiment of a prior art system using only controls connected via a wire or wirelessly. In such an embodiment, controllers 294, such as a gaming controller, a joystick, a mouse, a keyboard or the like are connected to a computing environment 12 either with a cable 292 or wirelessly. Pressing particular buttons or keys may cause set signals to be sent to the computing environment. When a user presses a button, the computing environment may respond in a pre-set manner. Further, these controllers are typically associated with specific physical ports 290. In an example of a prior art gaming environment, controller 1 may be plugged into a first physical port, controller 2 may be plugged into a second physical port etc. The controller 1 may have associated therewith primacy of control, or control of certain aspects of the gaming environment that are not available to the other controllers. For example, when selecting a specific level or board in a fighting game, only the first controller may be able to choose.

A gesture-based system, such as gesture-based system 10, may need to associate certain capabilities, features, rights, and privileges with a user without using the physical cables and physical ports of the prior art. If there are multiple users, each associated with a virtual port, the users may need feedback to determine with which ports they are associated. If, after initial association of a user to a virtual port, the port needs to be re-associated with a second user, both users may need some feedback to indicate that the virtual port has re-associated. When the virtual ports re-associate with different users, additional audio or visual feedback (in addition to the standard feedback that may be displayed continually) may be provided at or near the time of the re-association to further alert the users that the re-association has occurred. The user may need to be informed about other aspects of the computing environment and the user avatar may change in one or more ways to provide feedback about the computing environment.

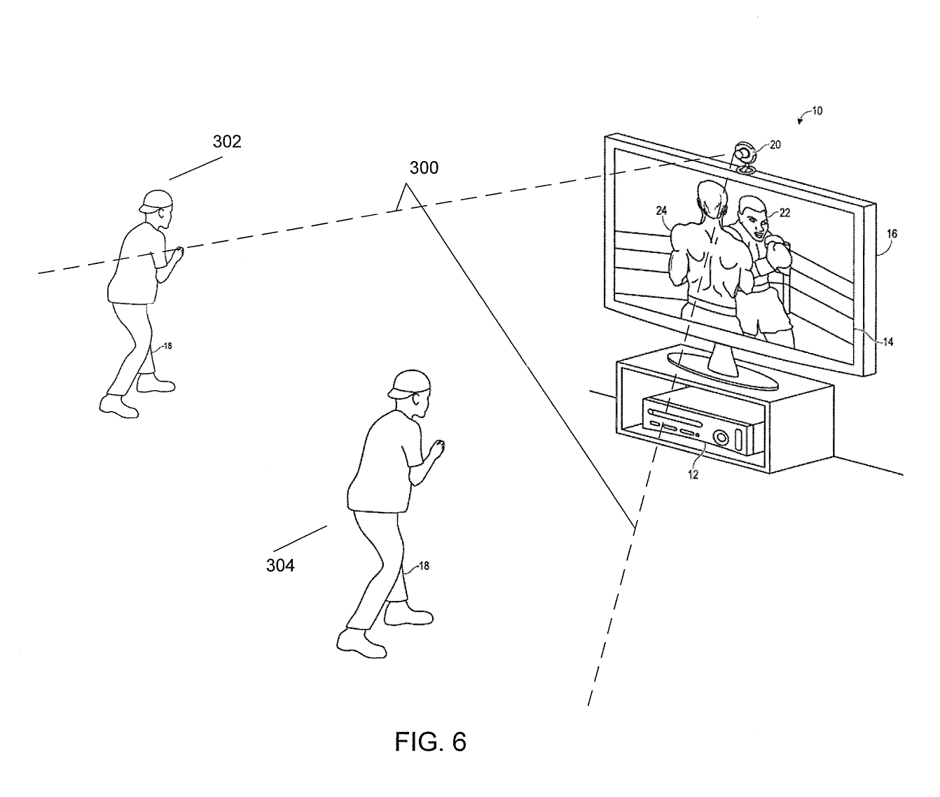

FIG. 6 illustrates a capture area 300 that may be captured by capture device 20 as described above with regard to FIGS. 1A-1C. A user 302 may be situated partially in a capture area 300. In FIG. 6, the user 302 is not fully within the capture area 300 of capture device 20, which may mean that the gesture-based system 10 may not be able to perform one or more actions associated with the user 302. In such an event, feedback provided to the user 302 by computing environment 12, or capture device 20 or by audiovisual display 16 may alter one or more aspects of an avatar associated with the user.

In another embodiment, a user such as user 304 may be in the capture area 300. In such an event, the gesture-based control system 10 may have bound the user 304 as a controller of the gesture-based control system. Feedback may be provided by an avatar to user 304 about one or more of the user's player number, the extent and type of control the user has over the computer environment or the avatar, the user's current poses and gestures and any associated features rights and privileges.

If multiple users are in a capture area 300, the gesture-based control system may provide feedback about the features, rights and privileges associated with each user in the capture area. For example, all users in the capture area may have a respective avatar that responds to each user's motion or poses and changes one or more ways based on the features, rights and privileges associated with each user.

A user may step too far from the capture device, too close to it, or too far to either the left or the right. In such a circumstance, the gesture-based control system may provide feedback in the form of either an ‘out of range’ signal, or specific feedback informing a user that he may need to move in a particular direction in order for the capture device to properly capture his image. For example, if a user 304 moves too far to the left, an arrow may pop up on the screen directing him back to the right, or the avatar may point in the direction the user needs to move. Such directions provided to a user may also be provided via the avatar, on the capture device, or by the computing environment. An audio signal may accompany the visual feedback described above.

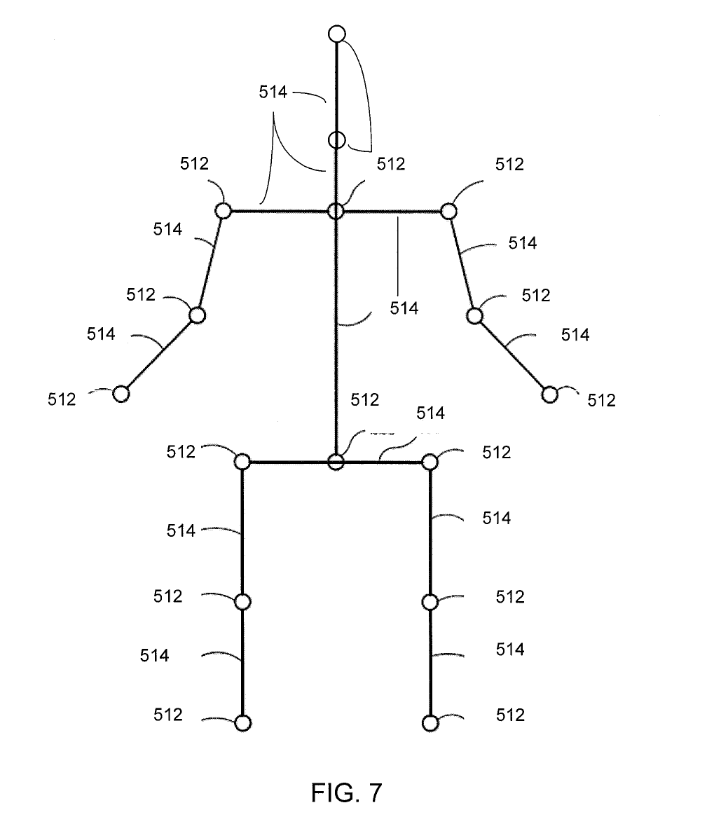

FIG. 7 depicts a skeletal model of a human user 510 that may be created using the capture device 20 and the computing environment 12. This model may be used by one or more aspects of the gesture-based system 10 to determine gestures and the like. The model may be comprised of joints 512 and bones 514. Tracking these joints and bones may allow the gesture-based system to determine what gestures a user is making. These gestures may be used to control the gesture-based system. Further, the skeletal model may be used to construct an avatar and to track a user's gestures to control one or more aspects of the avatar.

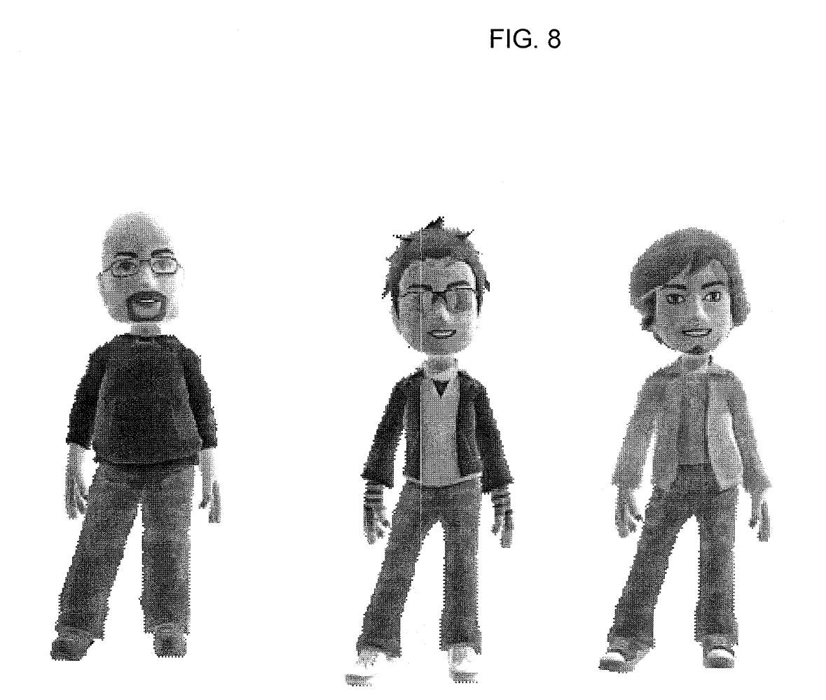

FIG. 8 depicts three example avatars that may each be used as a depiction of a user in a gesture-based environment. In one embodiment, a user may create an avatar using menus, tables and the like. For example, features such as hair color, height, eye color and the like may be selected from one of any number of options. In another embodiment, the capture device may capture a skeletal model of a user along with other information about the user. For example, the skeletal model may give bone locations and one or more cameras may provide an outline of the user. RGB cameras may be used to determine the color of hair, eyes, clothing, skin and the like. Thus an avatar may be created based on aspects of the user. Further, the computing environment may create a representation of the user, which the user may then adapt using one or more tables, menus or the like.

As a further example, the system may create random avatars or have pre-created avatars which a user may be able to select. The user may have one or more profiles that may contain one or more avatars which may be selected by the user or the system for a particular gaming session, mode of play or the like.

The avatars depicted in FIG. 8 may track to motions that a user may make. For example, if a user in a capture area raises his or her arm, the avatar's arm may also raise. This may provide information to the user about the motion of the avatar based on the user's motions. For example, the user may be able to determine which is the right hand and which is the left hand of the avatar by raising his or her hands. Further, the responsiveness of the avatar may be determined by making a series of motions to see how the avatar responds. As another example, if an avatar is limited in a particular environment (i.e. the avatar cannot move its legs and feet), the user may determine this fact by trying to move his or her legs and receiving no response from the avatar. Further, certain gestures may control the avatar in ways not directly related to a user's gesture. For example, in a racing game putting one foot forward or backward may cause a vehicle to accelerate or decelerate. The avatar may provide feedback about the control of the vehicle based on such a gesture.

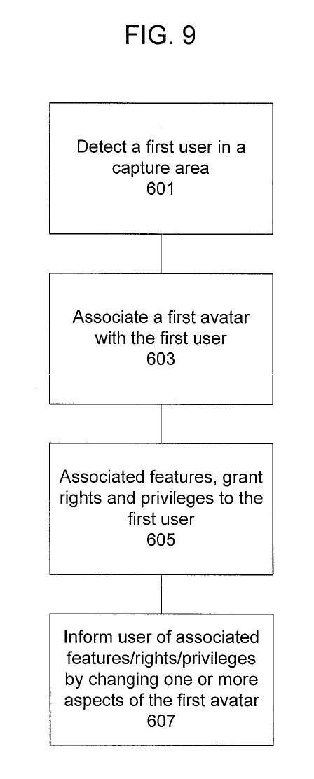

FIG. 9 is a flow chart illustrating one embodiment of a method by which a user is detected in a capture area at 601 and associated with a first avatar at 603. The avatar may be associated with the first user at 603 by the gesture-based system recognizing the user and associating with the avatar, or by allowing the user to select either a profile or an avatar from a table. As another example, the avatar may be created either automatically or via selections from one or more tables, menus and the like and then associated with the user at 603. As another example, the avatar may be randomly selected and associated with the user at 603. Unlike systems in which an avatar is associated with a particular physical controller, in the illustrated method the avatar is associated with a user that has been recognized via the capture device 20 and computing environment 12 of the gesture-based system 10.

At 605, capabilities, features, rights, and/or privileges may be associated with the recognized user. The capabilities, features, rights and/or privileges may be any capability, feature, right and/or privilege available in a gesture-based computing environment. Some examples, without limitation include, user permissions within a game or application, menu selection options available to the user, the right to input gesture-based commands, player number assignments, detection determinations, association with virtual ports, binding information, responsiveness of the gesture-based system to gestures, profile options or any other aspect of a gesture-based computing environment.

At 607, the user may be informed of one or more associated capabilities, rights, features and/or privileges in the user's computing session by changing one or more aspects of the avatar associated with the recognized user. For example, the avatar may change color, increase or decrease in size, brighten or dim, gain a halo or another object, move up or down on the screen, reorder itself with other avatars in a circle or a line, or the like. The avatar may also move or pose in one or more ways in order to provide feedback to a user of the gesture-based computing environment.

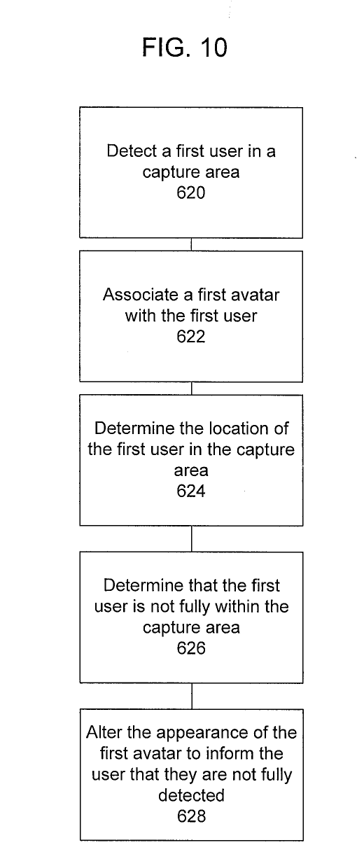

FIG. 10 is a flow diagram illustrating an embodiment of a method for informing a user via a user avatar that one or more body parts are not detected in the capture area of a gesture-based computing environment. At 620, a first user may be detected in a capture area such as, for example, capture area 300 described above with respect to FIG. 6. At 622, an avatar may be associated with the first user as described above. At 624, the gesture-based computing environment may determine the location of the first user in the capture area. This location may be determined using any combination of the systems described above, such as, for example, capture device 20, computing environment 12, cameras 26 and 27 or any other elements to build a model of a user and determine the user's position in the capture area 300.

At 626, the gesture-based computing environment may determine that part of the first user is not detected in the capture area. When the system determines that one or more body parts of a user are not within the capture area, the appearance of the first avatar may alter in one or more ways to inform the first user at 628 that they are not fully detected. For example, if one of the arms of a user is outside of the capture area of the gesture-based computing environment, the corresponding arm on the avatar may change appearance. The appearance may change in any way, including but not limited to a change in the color, brightness, size, or shape, or by placing an object on or around the arm, such as a halo, directional arrow, number, or any other object. As another example, if the user fully moves out of the capture area, or moves too close to the capture device the avatar may change in one or more ways to inform the first user that they are not properly detected. In such an event, a display may be provided on the display screen to inform the first user the direction they must move. Further, one or more aspects of the avatar as described above may change to provide feedback to the user of both their non-detection state and progress into a detection state.

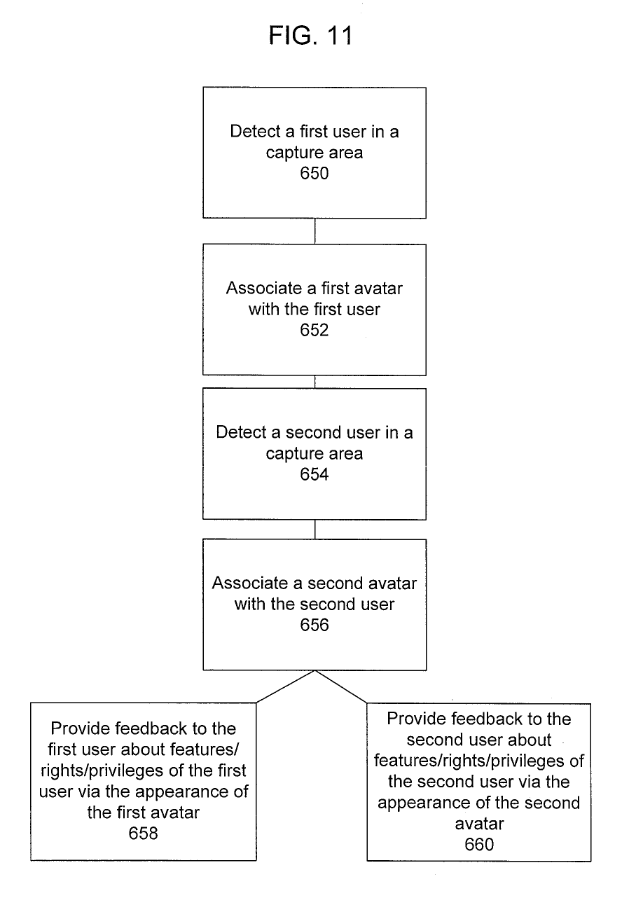

FIG. 11 is a flow chart illustrating an embodiment for detecting multiple users, associating an avatar to each user and providing feedback to each user via each user's avatar. In FIG. 11 at 650, the first user may be detected in a capture area and have the first avatar associated with it at 652. At 654, a second user may be detected in a capture area and a second avatar may be associated with the second user at 656. At 658, as described above, feedback may be provided to the first user via the first avatar about one or more features, right and/or privileges of the gesture-based computing environment. Similarly, at 660, feedback may be provided to the second user via the second avatar about one or more features, rights and/or privileges of the gesture-based computing environment.

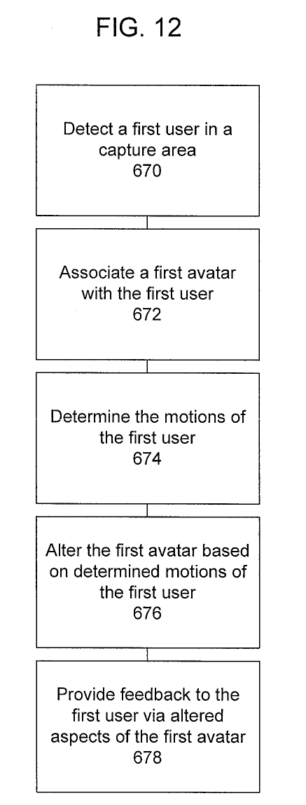

FIG. 12 is a flow chart illustrating an embodiment for providing feedback to a user about the response of a gesture-based computing environment to his motions via a user avatar. In FIG. 12 at 670, a first user is detected in a capture area. At 672, a first avatar is associated with the first user. The first user may be tracked and modeled using the methods described above, and motions or poses of the first user may be determined at 674. The first avatar may adapt in one or more ways at 676 based on the motions determined at 674. For example, if the first user raises their arm, the avatar may also raise their arm. From watching the avatar, the first user may be provided with feedback about aspects of the computing environment and the avatar. For example, a user may receive feedback about which arm on their body is associated with one of the avatars arms. As another example, a user receives feedback informing them that they do not need to fully extend their arm in order for the avatar to fully extend its arm.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Additionally, the subject matter of the present disclosure includes combinations and sub-combinations of the various processes, systems and configurations, and other features, functions, acts, and/or properties disclosed herein, as well as equivalents thereof

What is claimed:

1. A method comprising:
determining that a first user is bound to a first virtual port;
assigning a first avatar to the first user;
determining that a second user is bound to a second virtual port;
assigning a second avatar to the second user;
reassigning the second user from the second virtual port to the first virtual port in response to the first user becoming unbound from the first virtual port; and
providing feedback, via the second avatar, indicating the second user has been reassigned from the second virtual port to the first virtual port.

2. The method of claim 1 further comprising:
modifying the appearance of the second avatar to provide feedback to the second user, the feedback indicative of a set of capabilities, features, rights or permissions of the second user.

3. The method of claim 1 wherein the first user is indicated as an active player by a presence of the first avatar and an absence of the second avatar on the display screen.

4. The method of claim 1, further comprising:
receiving a depth image of a scene;
processing the depth image;
recognizing, in the depth image, a presence of the first user in the scene;
recognizing, in the depth image, a presence of the second user in the scene; and
recognizing that one or more body parts of the first user are not detected in the scene, and based on that recognition, modifying aspects of the first avatar to visually indicate to the user that the one or more body parts are not detected, the modified aspects selected from the group consisting of color, brightness, size, and addition of an object.

5. The method of claim 4, further comprising:
associating movements of the first user determined from changes in the depth image received over time with movements of the first avatar; and
associating movements of the second user determined from changes in the depth image received over time with movements of the second avatar.

6. The method of claim 1 wherein providing feedback, via the second avatar, indicating the second user has been reassigned from the second virtual port to the first virtual port comprises altering a size, a color, or a brightness of the second avatar.

7. The method of claim 1 wherein providing feedback, via the second avatar, indicating the second user has been reassigned from the second virtual port to the first virtual port comprises modifying the appearance of the second avatar by adding or removing a halo around, an underline beneath, or an arrow or other indicating mark near the second avatar.

8. The method of claim 1 wherein providing feedback, via the second avatar, indicating the second user has been reassigned from the second virtual port to the first virtual port comprises modifying the appearance of the second avatar by placing a number, name or object on or near the second avatar.

9. The method of claim 1 wherein providing feedback, via the second avatar, indicating the second user has been reassigned from the second virtual port to the first virtual port comprises modifying the appearance of the second avatar by ordering the second avatar in a particular geometric arrangement comprising a line or a circle.

10. The method of claim 1 wherein providing feedback, via the second avatar, indicating the second user has been reassigned from the second virtual port to the first virtual port comprises providing feedback indicating the second user has been reassigned from the second virtual port to the first virtual port after the first user becomes unbound from the first virtual port.

11. A computer-readable storage device having stored thereon computer executable instructions that, upon execution by a computing system, cause the computing system to perform operations comprising:
determining that a first user is bound to a first virtual port;
assigning a first avatar to the first user;
determining that a second user is bound to a second virtual port;
assigning a second avatar to the second user;
reassigning the second user from the second virtual port to the first virtual port in response to the first user becoming unbound from the first virtual port; and
providing feedback, via the second avatar, indicating the second user has been reassigned from the second virtual port to the first virtual.

12. The computer-readable storage device of claim 11, further comprising instructions that, upon execution by a computing system, cause the computing system to perform operations comprising:
modifying the appearance of the second avatar to provide feedback to the second user, the feedback indicating about at least one of capabilities, features, rights or permissions of the second user in the computing environment.

13. The computer-readable storage device of claim 11, further comprising instructions for indicating that the first user is an active player by a presence of the first avatar and an absence of the second avatar on the display screen.

14. The computer-readable storage device of claim 11, further comprising instructions that, upon execution by a computing system, cause the computing system to perform operations comprising:
receiving a depth image of a scene;
processing the depth image;
recognizing, in the depth image, a presence of the first user in the scene;
recognizing, in the depth image, a presence of the second user in the scene; and
recognizing that one or more body parts of the first user are not detected in the scene, and based on that recognition, modifying aspects of the first avatar to visually indicate to the user that the one or more body parts are not detected.

15. The computer-readable storage device of claim 14, further comprising instructions that, upon execution by a computing system, cause the computing system to perform operations comprising:
associating movements of the first user determined from changes in the depth image received over time with movements of the first avatar; and
associating movements of the second user determined from changes in the depth image received over time with movements of the second avatar.

16. The computer-readable storage device of claim 11, wherein providing feedback, via the second avatar, indicating the second user has been reassigned from the second virtual port to the first virtual port comprises modifying the appearance of the second avatar by altering a size, a color, or a brightness.

17. The computer-readable storage device of claim 11, wherein providing feedback, via the second avatar, indicating the second user has been reassigned from the second virtual port to the first virtual port comprises modifying the appearance of the second avatar by adding or removing a halo around, an underline beneath, or an arrow or other indicating mark.

18. The computer-readable storage device of claim 11, wherein providing feedback, via the second avatar, indicating the second user has been reassigned from the second virtual port to the first virtual port comprises modifying the appearance of the second avatar by placing a number, name or object on or near an avatar.

19. The computer-readable storage device of claim 11, wherein providing feedback, via the second avatar, indicating the second user has been reassigned from the second virtual port to the first virtual port comprises modifying the appearance of the second avatar by ordering an avatar in a particular geometric arrangement comprising a line or a circle.

20. The computer-readable storage device of claim 11, wherein providing feedback, via the second avatar, indicating the second user has been reassigned from the second virtual port to the first virtual port comprises providing feedback indicating the second user has been reassigned from the second virtual port to the first virtual port after the first user becomes unbound from the first virtual port.

21. A system comprising:
one or more computing processors; and
computing memory communicatively coupled with the one or more computing processors, the computing memory having stored therein executable instructions for performing operations comprising:
determining that a first user is bound to a first virtual port;
assigning a first avatar to the first user;
determining that a second user is bound to a second virtual port;
assigning a second avatar to the second user;
reassigning the second user from the second virtual port to the first virtual port in response to the first user becoming unbound from the first virtual port; and
providing feedback, via one or more of the first avatar and the second avatar, indicating the second user has been reassigned from the second virtual port to the first virtual port.

22. The system of claim 21, wherein the processor is programmed to perform operations further comprising:
modifying the appearance of one or more of the first avatar and the second avatar to provide feedback to the second user, the feedback indicating at least one of capabilities, features, rights or permissions of the second user in the computing environment.
